(19) United States
(12) Patent Application Publication
(10) Pub. No.: US 2026/0254315 A1
(43) Pub. Date: Aug. 27, 2026

(54) MOTOR MINIMIZING MOMENT LOADING WHILE MAINTAINING OPTIMIZED AXIAL ENCODER POSITION

(71) Applicant: Nidec Motor Corporation, St. Louis, MO (US)

(72) Inventors: John M. Tucker, St. Louis, MO (US); Michael W. Major, Moro, IL (US)

(73) Assignee: Nidec Motor Corporation, St. Louis, MO (US)

(21) Appl. No.: 19/330,911

(22) Filed: Sep. 17, 2025

Related U.S. Application Data
(60) Provisional application No. 63/763,753, filed on Feb. 26, 2025.

(51) Int. Cl. H02K 7/08; H02K 1/272; H02K 7/00; H02K 11/21

(52) U.S. Cl. CPC H02K 7/086; H02K 1/272; H02K 7/003; H02K 11/21

(57) ABSTRACT

A motor includes a rotor, a stationary shaft, a bearing, and an encoder. The rotor includes a rotor core rotatable about an axis. The rotor further includes an output component secured to the rotor core to rotate therewith. The stationary shaft is located radially inward relative to the rotor core. The bearing is interposed between the stationary shaft and the rotor core, such that the stationary shaft rotatably supports the rotor core and the output component. The encoder is located in general axial alignment with the stationary shaft.

### CROSS-REFERENCE TO RELATED APPLICATION

### Field of the Invention

The present application claims priority from U.S. Provisional Patent Application No. 63/763,753, filed February 26, 2025, and entitled MOTOR DESIGN MINIMIZING MOMENT LOADING WHILE MAINTAINING OPTIMIZED AXIAL ENCODER POSITION, the entire disclosure of which is hereby incorporated by reference herein.

### BACKGROUND OF THE INVENTION

### Field of the Invention

The present invention relates generally to a motor for rotating a platform configured to carry a load. The motor may be subject to significant offset loads and resulting moments (for instance, as a result of a crash or impact on the motor). Such moment loading, if not properly counteracted or accommodated for, may result in detrimental misalignments or other effects that may hinder motor performance.

### Discussion of the Prior Art

Electric motors conventionally include a rotor rotatable about an axis. Such motors may also include an encoder for measuring rotational parameters of the rotor. Centralized positioning of the encoder is desirable. However, in motors subject to off-axis loading, mitigation techniques to reduce the effects of moment loads may in some instances necessitate non-centralized, non-axially aligned positioning of the encoder. Such positioning is not optimal. The present invention minimizes moment loading while maintaining optimized axial encoder position and minimizing detrimental or expensive motor modifications in a broad sense.

### SUMMARY

According to one aspect of the present invention, a motor comprises a rotor, a stationary shaft, a bearing, and an encoder. The rotor includes a rotor core rotatable about an axis. The rotor further includes an output component secured to the rotor core to rotate therewith. The stationary shaft is located radially inward relative to the rotor core. The bearing is interposed between the stationary shaft and the rotor core, such that the stationary shaft rotatably supports the rotor core and the output component. The encoder is located in general axial alignment with the stationary shaft.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is a cross-sectional front view of a prior art motor;

FIG. 2 is a top perspective view of a motor in accordance with a preferred embodiment of the present invention;

FIG. 3 is a partially sectioned top perspective view of the motor of FIG. 2;

FIG. 4 is a cross-sectional view of the motor of FIGS. 1 and 2;

FIG. 5 is an enlarged cross-sectional view of the motor of FIGS. 1-3; and

FIG. 6 is an exploded perspective view of the motor of FIGS. 2-6.

The drawing figures do not limit the present invention to the specific embodiments disclosed and described herein. While the drawings do not necessarily provide exact dimensions or tolerances for the illustrated structures or components, the drawings are to scale with respect to the relationships between the components of the structures illustrated in the drawings.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

Furthermore, unless specified or made clear, the directional references made herein with regard to the present invention and/or associated components (for instance, top, bottom, upper, lower, inner, outer, and so on) are used solely for the sake of convenience and should be understood only in relation to each other. For instance, a component might in practice be oriented such that faces referred to as “top” and “bottom” are sideways, angled, inverted, and so on relative to the chosen frame of reference.

### Prior Art Motor

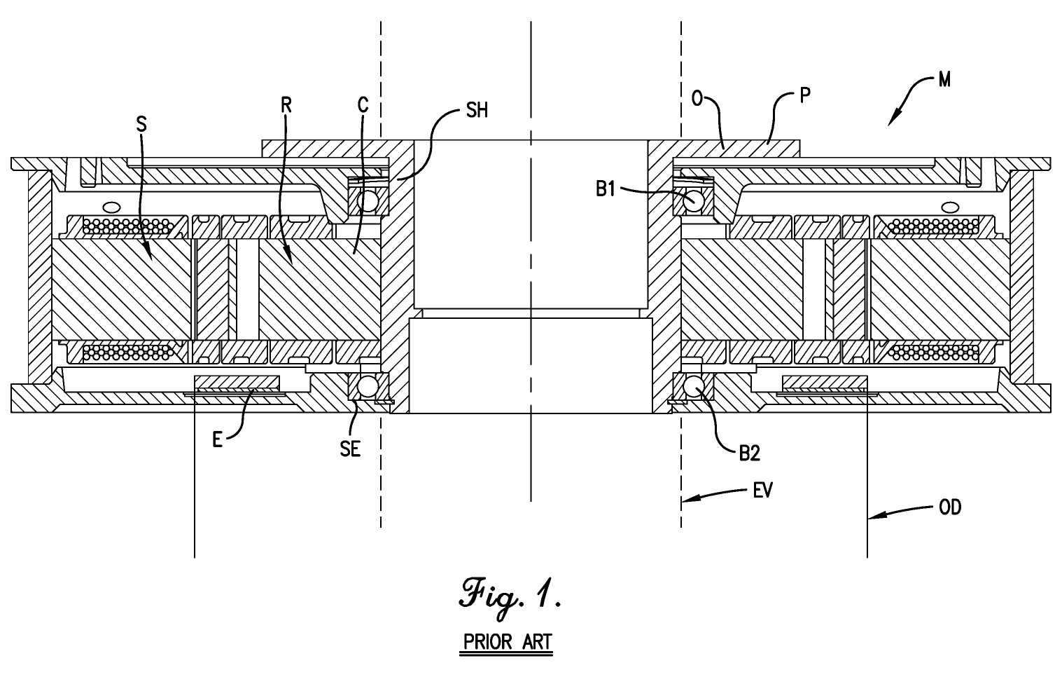

A prior art motor M for rotating a platform or plate P is illustrated in FIG. 1. The motor M includes a rotor R and a stator S. The rotor R includes a rotor core C and a central rotating shaft SH that rotates about an axis A. The rotary shaft SH drives rotation of an output component O that includes or defines the platform P. Upper and lower bearings B1 and B2 are press-fit onto the outer surface of the shaft SH.

Due to space requirements, a custom encoder E is provided, with positioning of the encoder E being complicated due to the large diameter of the rotating elements (which are configured to endure sizeable loading or moments), such as the rotating shaft SH. As will be readily apparent to those having ordinary skill in the art, encoders are typically designed to be as small as possible and fit unobtrusively on the back of an associated motor. However, the illustrated motor M, with its large rotary shaft outer diameter, makes this approach unfeasible.

More particularly, the prior art custom encoder is in the form of a large ring that circumscribes the shaft SH and the lower bearings B2. Thus, although the encoder E extends about the same axis A as does the shaft SH, the encoder E is not disposed in axial alignment with the shaft SH. In the illustrated embodiment, for instance, a substantial portion (and, in fact, the entirety of the body) of the ring-like encoder E is disposed radially outside/past a radial envelope EV defined by the shaft SH. That is, the encoder E is not at least substantially contained (and, in the illustrated embodiment, not at all contained) within the radial envelope EV of the shaft SH.

Alternatively described, the shaft SH has an outer diameter corresponding to the envelope EV. The encoder E has an outer diameter OD. About fifty-five percent (55%) of the radial extent of the encoder E is disposed outside of the shaft envelope EV. Stated another way, the outer diameter of the encoder E is more than two (2) times the diameter of the shaft SH and, in the illustrated embodiment, is about two and twenty-five hundredths (2.25) times the diameter of the shaft SH.)

Furthermore, it is noted that space requirements limit the width and thickness (or height) of the races of the bearings B1 and B2, with the ratios of the width and thickness of each bearing race to the inner diameter of the corresponding one of the bearings B1 and B2 being unconventionally low.

### Motor Overview – Preferred Embodiment

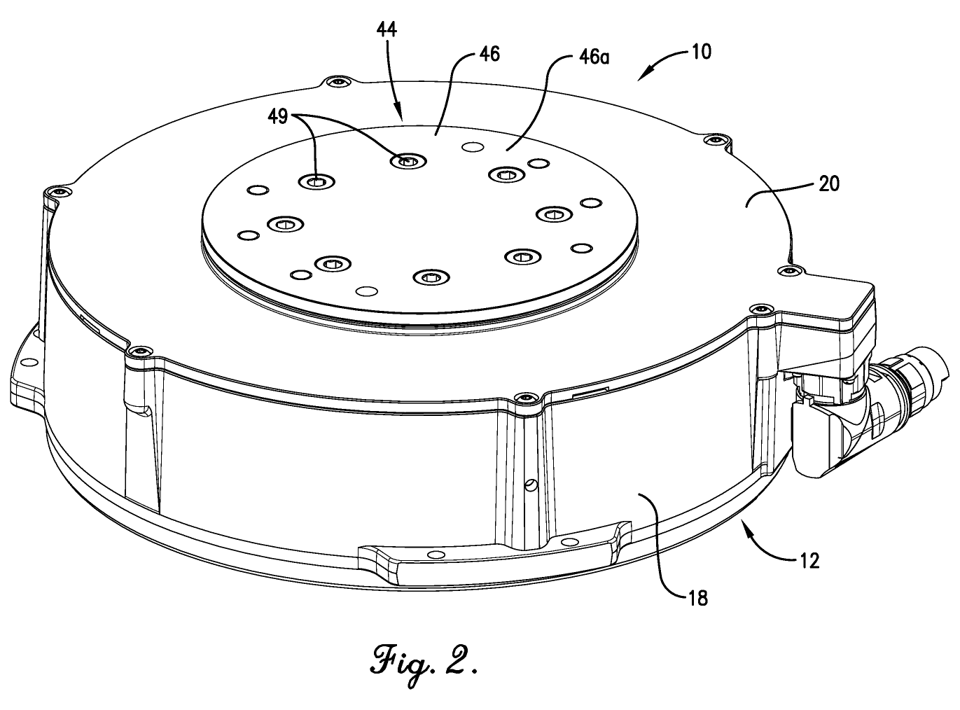

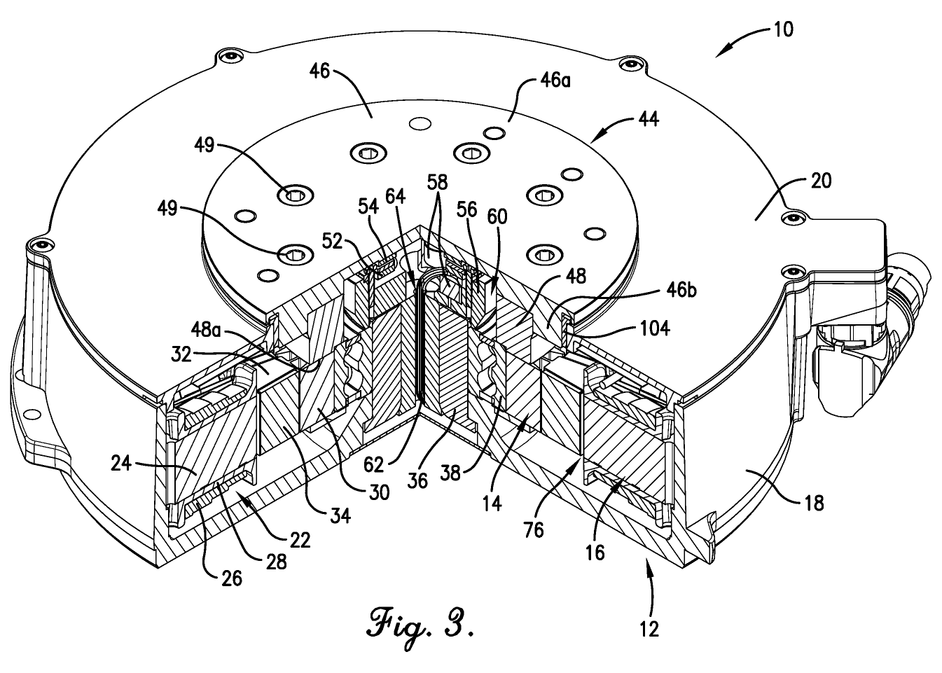

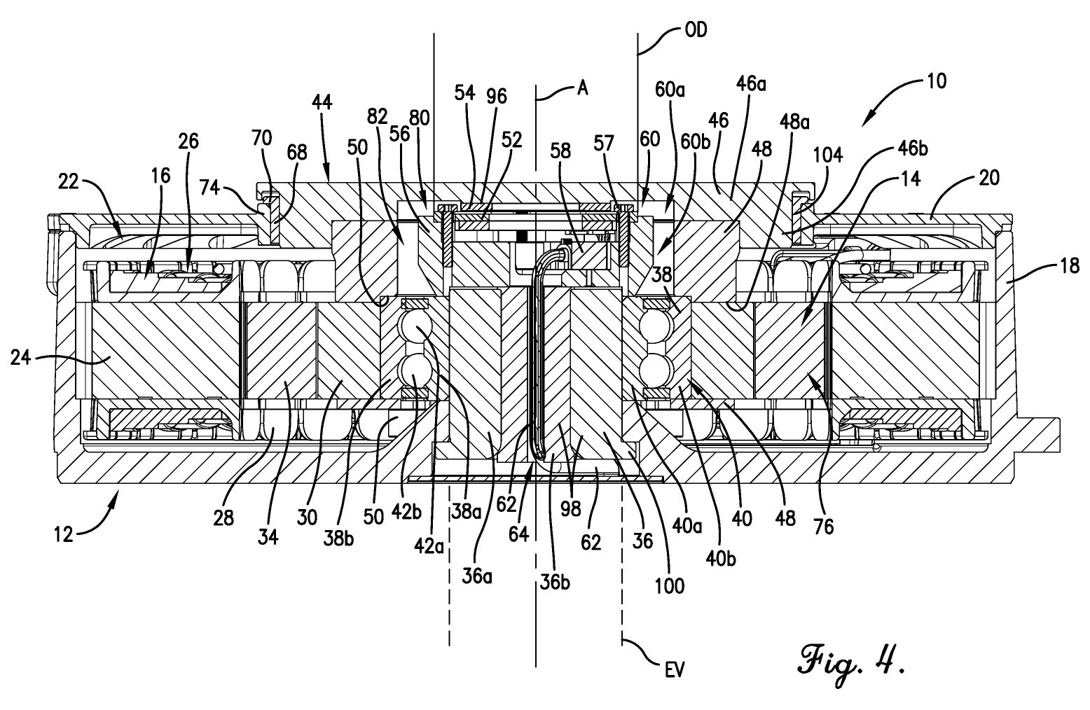

FIGS. 2-8 illustrate a motor 10 in accordance with a preferred embodiment of the present invention. The motor 10 broadly includes a housing 12, a rotor 14, and a stator 16. The housing 12 includes a motor shell or can 18 and a top or cover 20 secured to the shell 18. The top 20 and the motor shell 18 cooperatively at least in part define a motor chamber 22 at least in part receiving the rotor 14 and the stator 16 therein. More particularly, in the illustrated embodiment, the stator 16 is received in its entirety within the motor chamber 22, whereas the rotor 14 is at least substantially received therein.

The motor shell 18 preferably comprises aluminum, although other materials fall within the scope of some aspects of the present invention.

The stator 16 preferably includes a stator core 24 and a plurality of coils 26 wound about the core 24. The stator 16 is preferably provided with an electrically insulative covering 28 at least in part disposed between the coils 26 and the stator core 24. The covering 28 is in the form of end caps in the illustrated embodiment; however, other insulation techniques may alternatively or additionally be used.

The rotor 14 preferably includes a rotor core 30 comprising a plurality of arcuately spaced apart pole segments 32. The rotor 14 further preferably includes a plurality of arcuately spaced apart magnets 34 alternating arcuately with the pole segments 32. The rotor is rotatable about a rotor axis A.

The motor 10 also includes a centrally disposed, stationary shaft 36. That is, the shaft 36 is a non-rotating shaft located radially inwardly relative to the rotor core 30.

The shaft 36 and the shell 18 are preferably secured to one another via a hot drop, shrink fit process. However, other means of securement, including but not limited to integral formation, may additionally or alternatively be used.

The shaft 36 is preferably encircled by a single bearing 38. More particularly, the bearing 38 is interposed between the stationary shaft 36 and the rotating rotor core 30, such that the shaft 36 rotatably supports the rotor core 30 (and, more broadly, the rotor 14).

The bearing 38 is preferably a double-row or stacked bearing including a bearing housing 40, a first set of rolling elements 42a disposed within the housing 40, and a second set of rolling elements 42b disposed within the housing 40 and located in general axial alignment with the first set of rolling elements 42a. In the illustrated embodiment, for instance, the bearing 38 is a double-row angular contact (DRAC) bearing.

It is permissible according to some aspects of the present invention, however, for the stacked bearing to be replaced with a pair of adjacent, axially stacked single-layer bearings or a pair of axially spaced apart single-layer bearings.

In a preferred embodiment of the present invention, the bearing 38 is press fit into the inner diameter of the rotor core 30 so as to be disposed radially between the shaft 36 and the rotor core 30. More particularly, the bearing housing 40 includes a fixed inner race 40a that engages the (fixed) shaft 36 and a rotating outer race 40b that engages the (rotatable) rotor core 30.

It is particularly noted that the bearing 38 extends axially along a significant extent of the shaft 36. For instance, the bearing 38 preferably extends along more than thirty (30) percent, more preferably more than forty (40) percent, and most preferably more than fifty (50) percent of the axial length of the shaft 36. This high percentage of extension and contact, in combination with other motor features, results in the shaft 36 being strongly secured against rotation or bending due to radial forces and against other undesirable shifting or deformation.

Described another way, the bearing 38 is designed and positioned relative to the shaft 36 such that minimal cantilevering of the shaft 36 occurs relative to the bearing 38. That is, the bearing 38 provides substantial support to the shaft 36.

The rotor 14 further preferably includes a rotatable output component 44 secured to the rotor core 30 to rotate therewith, such that the output component 44 transfers or transmits torque from the rotor core 30.

The output component 44 in the illustrated embodiment includes an output projection 46 and an adapter 48. The adapter 48 is disposed axially between the rotor core 30 and the output projection 46.

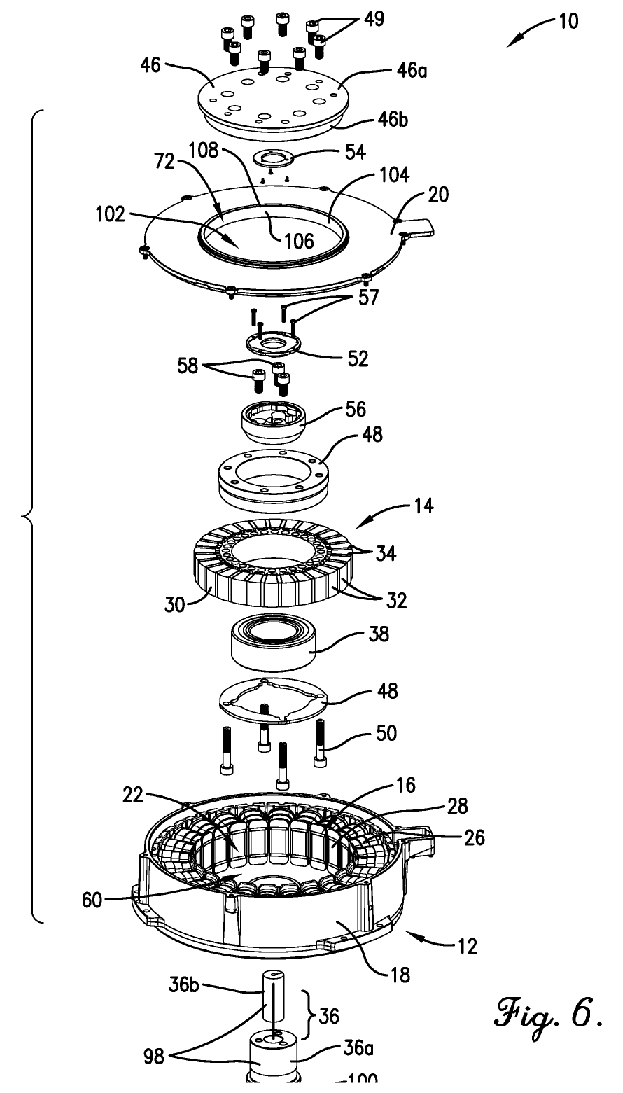

The output projection 46 is preferably secured to the adapter 48 via a plurality of fasteners 49 (see FIGS. 2, 3, and 6). The adapter 48 is in turn preferably secured to the rotor core 30 via a plurality of fasteners 50 (see FIG. 6). The adapter 48 transfers torque from the rotor core 30 to the output projection 46, which is in turn configured to transmit torque to an external load or other output.

In a preferred embodiment of the present invention, the output projection 46 includes a radially extending platform or plate 46a configured to carry goods or other load sources. That is, a load may be applied to the plate 46a,with such load in some instances being offset from the rotor axis A.

Although a plate-like form of the output projection 46 is illustrated, it is noted that various configurations of the output projection fall within the scope of some aspects of the present invention. For instance, rather than including a plate-like structure, the output projection could in some embodiments be bowl-like or box-like.

The motor 10 further includes an encoder 52. The encoder 52 is preferably a standard, off-the-shelf encoder (as opposed to being custom produced, as in the motor M). A target 54 to be read by the encoder 52 is preferably provided on an underside of the rotating plate 46a of the output projection 46.

The encoder 52 is preferably an inductive encoder, although other encoder types fall within the scope of some aspects of the present invention.

In a preferred embodiment of the present invention, the encoder 52 is mounted on an encoder holder 56 that is secured to the stationary shaft 36.

In the illustrated embodiment, for instance, the encoder 52 is mounted to the encoder holder 56 using a plurality of fasteners 57; and the encoder holder 56 is secured to the shaft 36 via a plurality of fasteners 58. Alternative suitable means for securing the encoder 52 to the encoder holder 56 and the encoder holder 56 to the shaft 36 are within the ambit of some aspects of the preferred embodiments.

The encoder holder 56 preferably comprises steel, although other materials may be used without departing from the scope of the present invention.

The encoder 52 is preferably received within an encoder chamber 60.

Wiring 62 preferably extends from the encoder 52, through a lumen 64 in the stationary shaft 36, and thereafter away from the motor 10. More particularly, in the illustrated embodiment, the shaft 36 includes an outer sleeve 36a and an inner core 36b received within the sleeve 36a. The lumen 64 is formed through the core 36b. Alternative shaft designs, including but not limited to unitary designs, fall within the scope of some aspects of the present invention, however.

The encoder 52, the target 54, the encoder holder 56, and the encoder chamber 60 will be described in greater detail below, particularly in relation to the output component 44 and the shaft 36.

### Output Component Structure and Positioning

As noted previously, the output component 44 in the illustrated embodiment includes an output projection 46 and an adapter 48. The adapter 48 is disposed axially between the rotor core 30 and the output projection 46.

As also noted previously, the output projection 46 preferably includes the radially extending platform or plate 46a.

In a preferred embodiment, the output projection 46 further includes a generally annular, axially extending rim 46b projecting from the plate 46a toward the rotor core 30. The rim 46b circumscribes the adapter 48, with the rim 46b and a bottom face of the plate 46a cooperatively forming an adapter seat 66 against which the adapter 48 is seated. That is, the adapter 48 preferably engages the output projection 46 at the adapter seat 66.

In the illustrated embodiment, the rim 46b extends continuously so as to endlessly circumscribe the adapter 48. However, discontinuities fall within the scope of some aspects of the present invention.

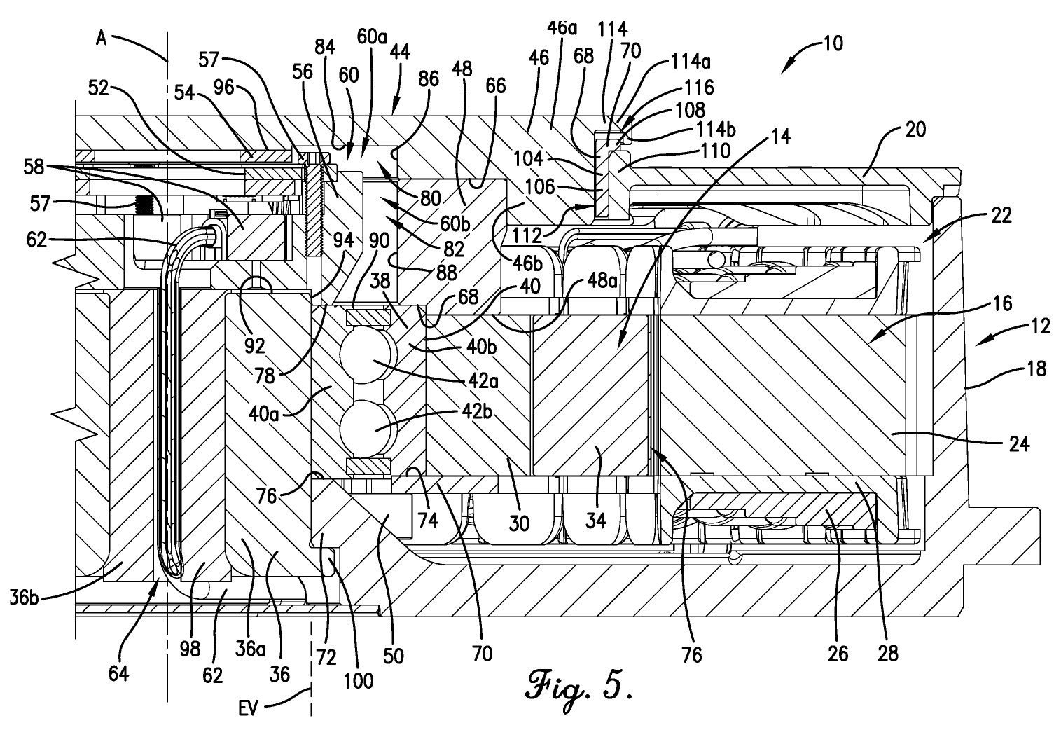

The output component 44 also preferably aids in seating of the bearing 38. More particularly, in a preferred embodiment, the adapter 48 includes a bottom surface 48a that both engages the rotor core 30 and, as best shown in FIG. 5, defines an upper, outer bearing seat 68 against which the outer bearing race 38b is seated.

As also best shown in FIG. 5, a bearing retainer 70 and a central mounting cone 72 formed by the housing 12 provide inner and outer lower bearing seats 74 and 76, respectively; and the encoder holder 56 provides an upper, inner bearing seat 78.

### Encoder Chamber and Encoder Positioning

In a preferred embodiment of the present invention, the output component 44 at least in part defines the aforementioned encoder chamber 60 in which the encoder 52 and the holder 56 are at least in part, and most preferably in their entirety, received. More particularly, it is preferred that the output projection 46 and the adapter 48, along with the rotor core 30 and the shaft 36, cooperatively define the encoder chamber 60.

In greater detail still, the plate 46a of the output projection 46 preferably defines an at least substantially cylindrical recess 80 forming a top portion 60a of the encoder chamber 60. An at least substantially cylindrical region 82 defined by the adapter 48 forms a bottom portion 60b of the encoder chamber 60.

Alternatively described, and as best shown in FIG. 5, the encoder chamber 60 in the illustrated embodiment is defined by lower and inner surfaces 84 and 86 of the plate 46a, an inner surface 88 of the adapter 48, an upper surface 90 of the bearing 38, and upper and outer surfaces 92 and 94 of the shaft 36.

In the illustrated embodiment, the encoder holder 56 is primarily received within the bottom portion 60b of the encoder chamber 60, so as to be circumscribed by the adapter 48.

The encoder 52 is preferably mounted on the encoder holder 56, so as to be positioned in both the top portion 60a of the encoder chamber 60 (that is, in the recess 80 of the plate 46a) and in an upper region of the bottom portion 60b of the encoder chamber 60 (that is, at the top of the region 82 defined by the adapter 48). The encoder 52 is thus circumscribed by both the output projection 46 and the adapter 48.

The output projection 46 preferably defines a boss 96 to which the encoder target 54 is mounted. More particularly, in the illustrated embodiment, the plate 46a defines the boss 96. The boss 96 projects into the encoder chamber 60, with the target 54 being mounted to the boss 96 to rotate with the output projection 46. As will be readily apparent to those of ordinary skill in the art, the target 54 is positioned relative to the encoder 52 to facilitate reading of the target 54 by the encoder 52.

It is particularly noted that, in a preferred embodiment of the present invention and as illustrated, the encoder 52 is located in general axial alignment with the stationary shaft 36. Indeed, not only do the shaft 36 and the encoder 52 share the axis A with each other and with the rotor 14, but only a very small portion of the encoder 52 extends radially past a radial envelope EV defined by the shaft 36. That is, the encoder 52 is at least substantially contained within the radial envelope EV of the shaft 36.

More particularly, the shaft 36 includes a main body 98 and a radially outwardly extending flange 100. The sleeve 36a in the illustrated embodiment defines the flange 100 and a portion the main body 98, whereas the core 36 defines only a portion of the main body 98. The main body 98 presents an outer surface 98a. The radial envelope EV of the shaft 36 corresponds to the outer surface 98a. Alternatively stated, the radial envelope EV of the shaft 36 can be understood to extend along the outer surface 98a and axially therepast.

In the illustrated embodiment, the main body 98 of the shaft 36 has an outer diameter (corresponding to the radial envelope EV) of about one and ninety-seven hundredths (1.97) inches. The encoder 52 has an outer diameter OD of about two and thirty-two hundredths (2.32) inches. Thus, preferably less than about twenty-five percent (25%) of the radial extent of the encoder 52 is disposed outside of the main shaft envelope EV. More preferably, less than about twenty percent (20%) of the radial extent of the encoder 52 is disposed outside of the main shaft envelope EV, and most preferably less than about sixteen percent (16%) of the radial extent of the encoder 52 is disposed outside of the main shaft envelope EV.

Alternatively characterized, the diameter OD of the encoder 52 is preferably less than about one and five tenths (1.5) times the diameter of the main body 98 of the shaft 36, more preferably less than about one and twenty-five hundredths (1.25) times the diameter of the main body 98, and most preferably less than about one and two tenths (1.2) times the diameter of the main body 98.

Similarly to the encoder 52, the target 54 is preferably located in general axial alignment with stationary shaft 36. Indeed, not only do the shaft 36 and the target 54 share the central axis A, but no portion of the target 54 extends radially past the radial envelope EV defined by a main body 98 of the shaft 36. That is, the target 54 is entirely contained within the radial envelope EV of the shaft 36.

The size, shape and/or positioning of the encoder 52 and its associated outer diameter OD relative to the main shaft envelope EV facilitates optimizing the space requirements of the encoder 52. The encoder 52 is optimally designed as small as possible and is positioned unobtrusively relative to the motor 10.

### Annular Bushing

The motor housing 12 preferably defines a motor chamber 60 in which the rotor core 30 and the stator 16 are at least substantially, and most preferably in their entirety, received. The housing 12 also preferably defines an output opening 102 through the top 20 (see FIG. 6). The output opening 102 preferably extends into the motor chamber 60.

In a preferred embodiment, as illustrated, the output component 44 extends through the opening 102, with the plate 46a (and anything loaded thereon) being accessible outside the motor housing 12.

The motor 10 preferably includes an annular bushing 104 disposed in the opening 102 and radially between the housing 12 and the output component 44. More particularly, the bushing 104 is disposed radially between the top 20 and the output projection 46 so as to encircle the output projection 46.

With reference to FIG. 5, the bushing 104 preferably includes a cylindrical sleeve 106 and a radially outwardly extending circumferential component or lip 108 extending from the sleeve 106.

With continued reference to FIG. 5, the top 20 preferably includes an axially extending retaining wall 110 that defines the opening 102. The bushing 104 preferably engages the retaining wall 110, with the sleeve 106 thereof being disposed in overlying engagement with an interior surface of the wall 110, and with the lip 108 extending over and resting upon an upper face of the wall 110.

The bushing 104 preferably comprises a resilient synthetic resin material and is configured to have a low wear rate and support high radial loads.

During normal, balanced, “true” operation of the motor 10, a small gap or clearance112 (see FIG. 5) is present between the bushing 104 and the output projection 46 of the output component 44, such that rotation of the output component 44 is unimpeded by the bushing 104. Even if slight contact were to occur, however, the bushing 104 is preferably self-lubricating and low friction so as to only minimally impede rotation of the component 44.

Similarly, and again with reference to FIG. 5, the output projection 46 preferably includes an outcropping 114 extending radially outwardly from the plate 46a. The outcropping 114 includes a radially extending ceiling portion 114a and an axially extending wall portion 114b extending downwardly from the ceiling portion 114a. The ceiling portion 114a preferably extends above the lip 108 of the bushing 104, and the wall portion 114b preferably in part extends axially alongside a radially outer edge of the lip 108. During normal, balanced, “true” operation of the motor 10, a small gap or clearance 116 is present between the bushing 104 and the outcropping 114, such that rotation of the output component 44 is unimpeded by the bushing 104. Even if slight contact were to occur, however, the bushing 104 is preferably self-lubricating and low friction so as to only minimally impede rotation of the component output projection 46.

It is noted that, during operation of the motor 10, abnormal circumstances, including but not limited to a malfunction, crash, or impact associated with the motor 10 itself or a device with which it is associated, may occur. Such circumstances may result in extreme moment loads (that is, overhung moment extremes) affecting the motor 10. Although the stacked bearing 38 is preferably able to absorb and accommodate substantial moment loads, extreme loads that cannot be fully accommodated by the bearing 38 may result in radial shifting of the output component 44 and ensuing contact between the bushing 104 and the output component. The bushing 104 is thereby operable to act as a “crash bushing” to resist the extreme moment load and prevent or at least resist bearing damage that might otherwise occur. The bushing 104 is likewise operable to prevent or at least resist twisting, flexing, or warping of the stator shell 18 that might otherwise occur.

That is, rather than an excessive offset load being transferred to the bearing 38, the stator shell or can 18, or another deformable or shiftable component, such load is supported radially by the bushing 104. Misalignment of the motor 10 and distortion of the conventional air gap between the stator 16 and the rotor 14 is avoided.

It is noted that, in an alternative embodiment of the present invention, the bushing could be replaced by a thin-race ball bearing.

It is also noted that, in some embodiments of the present invention, the bushing or other wear element or material could directly engage the output component rather than the housing. In such an embodiment, a clearance gap would preferably be defined between the bushing and the housing.

Still further, a separate wear element or material can be omitted entirely without departing from the scope of some aspects of the present invention due to the excellent control of tolerances that results from the motor design as described above (for instance, the axially stacked bearing 38 and its positioning and length relative to the shaft). In such an embodiment, a clearance gap would preferably be defined between the output and the housing themselves.

### Conclusion

Features described above may be used in various combinations with each other and/or may be used independently of one another. For instance, although a single disclosed embodiment may include a preferred combination of features, it is within the scope of certain aspects of the present invention for the embodiment to include only one (1) or less than all of the disclosed features, unless the specification expressly states otherwise or as might be understood by one of ordinary skill in the art. Therefore, embodiments of the present invention are not necessarily limited to the combination(s) of features described above.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

Although the above description presents features of preferred embodiments of the present invention, other preferred embodiments may also be created in keeping with the principles of the invention. Furthermore, as noted previously, these other preferred embodiments may in some instances be realized through a combination of features compatible for use together despite having been presented independently as part of separate embodiments in the above description.

What is claimed is:

1. A motor comprising:
a rotor including
a rotor core rotatable about an axis, and
an output component secured to the rotor core to rotate therewith;
a stationary shaft located radially inward relative to the rotor core;
a bearing interposed between the stationary shaft and the rotor core, such that the stationary shaft rotatably supports the rotor core and the output component; and
an encoder located in general axial alignment with the stationary shaft.

2. The motor of claim 1,
said output component at least in part defining an internal encoder chamber,
said encoder being disposed at least in part in said internal encoder chamber.

3. The motor of claim 2,
said output component including an adapter and an output projection,
said adapter being disposed axially between the rotor core and the output projection,
said output projection configured to transfer torque from the rotor core.

4. The motor of claim 3,
said output projection at least in part defining the internal encoder chamber.

5. The motor of claim 4,
said output projection including a radially extending plate,
said plate at least in part defining the internal encoder chamber.

6. The motor of claim 5,
said output projection further including an arcuately and axially extending rim,
said rim at least in part circumscribing the adapter.

7. The motor of claim 6,
said rim and said plate cooperatively defining an adapter seat,
said adapter engaging said adapter seat.

8. The motor of claim 4,
said adapter further defining the internal encoder chamber.

9. The motor of claim 3,
said adapter at least in part defining the internal encoder chamber.

10. The motor of claim 2,
said encoder being disposed in its entirety within the internal encoder chamber.

11. The motor of claim 2, further comprising:
a target mounted to the output component to rotate therewith,
said encoder configured to read the target.

12. The motor of claim 2,
said output component defining a bearing seat,
said bearing engaging said bearing seat.

13. The motor of claim 1, further comprising:
an encoder holder secured to the stationary shaft,
said encoder being mounted to the encoder holder.

14. The motor of claim 13,
said encoder holder defining a bearing seat,
said bearing engaging said bearing seat.

15. The motor of claim 13,
said output component including an adapter and an output projection,
said output projection configured to transfer torque from the rotor core,
said adapter being disposed axially between the rotor core and the output projection,
said adapter circumscribing said encoder holder.

16. The motor of claim 1,
said bearing being a double-row bearing,
said double-row bearing including
a housing,
a first set of rolling elements disposed within the housing, and
a second set of rolling elements disposed within the housing and located in general axial alignment with the first set of rolling elements.

17. The motor of claim 16,
said housing and said output component defining a circumferentially extending, radial clearance gap therebetween.

18. The motor of claim 16, further comprising:
an annular bushing disposed in the opening and radially between the housing and the output component,
said bushing comprising a sleeve circumscribing the output component and engaging one of said housing and said output component,
said sleeve and another of said housing and said output component defining a circumferentially extending, radial clearance gap therebetween.

19. The motor of claim 1,
a housing defining a motor chamber and an opening extending into the motor chamber,
said rotor core being at least substantially received in said motor chamber,
said output component extending through said opening to be at least in part disposed outside said motor chamber.

20. The motor of claim 1,
said stationary shaft and said encoder being coaxial,
said stationary shaft including a main body defining a stationary shaft main body outer diameter,
said encoder having an encoder outer diameter,
said encoder outer diameter being less than about 1.5 times the stationary shaft main body outer diameter.
